(19) United States
(12) Patent Application Publication
(10) Pub. No.: US 2003/0107217 A1
(43) Pub. Date: Jun. 12, 2003

(54) Sealant for expandable connection

(75) Inventors: Chan Daigle, Katy, TX (US); Michael Bullock, Aberdeen (GB); Andrei Filippov, Wassenaar (NL); Scott Costa, Kingwood, TX (US); Mike Cowan, Sugar Land, TX (US)

Correspondence Address: HAYNES AND BOONE, LLP, 1000 LOUISIANA, SUITE 4300, HOUSTON, TX, 77002, US

(73) Assignee: Shell Oil Co.

(21) Appl. No.: 10/331,718

(22) Filed: Dec. 30, 2002

Related U.S. Application Data
(62) Division of application No. 09/679,906, filed on Oct. 5, 2000.
(60) Provisional application No. 60/159,033, filed on Oct. 12, 1999.

(51) Int. Cl. F16L 33/18

(52) U.S. Cl. 285/355

(57) ABSTRACT

A sealant for an expandable connection. The threaded portions of a pair of expandable tubulars are coated with a sealant. The threaded portions of the expandable tubulars are then coupled. The sealant is cured. The expandable tubulars are then placed within a preexisting structure. The expandable tubulars are then radially expanded into contact with the preexisting structure.

### Cross Reference To Related Applications

This application is a division of U.S. patent application Ser. No. 09/679,906, attorney docket number 25791.37.02, which claims the benefit of the filing date of U.S. provisional patent application serial No. 60/159,033, attorney docket number 25791.37, filed on Oct. 12, 1999, the disclosures of which are incorporated herein by reference.

This application is related to the following co-pending applications:

| U.S. Provisional | | |
|---|---|---|
| Patent Application | Attorney | |
| Number | Docket No. | Filing Date |
| 60/108,558 | 25791.9 | Nov. 16, 1998 |
| 60/111,293 | 25791.3 | Dec. 7, 1998 |
| 60/119,611 | 25791.8 | Feb. 11, 1999 |
| 60/121,702 | 25791.7 | Feb. 25, 1999 |
| 60/121,841 | 25791.12 | Feb. 26, 1999 |
| 60/121,907 | 25791.16 | Feb. 26, 1999 |
| 60/124,042 | 25791.11 | Mar. 11, 1999 |
| 60/131,106 | 25791.23 | Apr. 26, 1999 |
| 60/137,998 | 25791.17 | Jun. 7, 1999 |
| 60/143,039 | 25791.26 | Jul. 9, 1999 |
| 60/146,203 | 25791.25 | Jul. 29, 1999 |
| 60/154,047 | 25791.29 | Sep. 16, 1999 |
| 60/159,082 | 25791.34 | Oct. 12, 1999 |
| 60/159,039 | 25791.36 | Oct. 12, 1999 |

Applicants incorporate by reference the disclosures of these applications.

### BACKGROUND OF THE INVENTION

This invention relates generally to wellbore casings, and in particular to wellbore casings that are formed using tubing having threaded portions.

Conventionally, when a wellbore is created, a number of casings are installed in the borehole to prevent collapse of the borehole wall and to prevent undesired outflow of drilling fluid into the formation or inflow of fluid from the formation into the borehole. The borehole is drilled in intervals whereby a casing which is to be installed in a lower borehole interval is lowered through a previously installed casing of an upper borehole interval. As a consequence of this procedure the casing of the lower interval is of smaller diameter than the casing of the upper interval. Thus, the casings are in a nested arrangement with casing diameters decreasing in downward direction. Cement annuli are provided between the outer surfaces of the casings and the borehole wall to seal the casings from the borehole wall. As a consequence of this nested arrangement a relatively large borehole diameter is required at the upper part of the wellbore. Such a large borehole diameter involves increased costs due to heavy casing handling equipment, large drill bits and increased volumes of drilling fluid and drill cuttings. Moreover, increased drilling rig time is involved due to required cement pumping, cement hardening, required equipment changes due to large variations in hole diameters drilled in the course of the well, and the large volume of cuttings drilled and removed.

The present invention is directed to overcoming one or more of the limitations of the existing procedures for forming wellbores.

### SUMMARY OF THE INVENTION

According to one aspect of the present invention, an expandable tubular assembly is provided that includes a pair of tubular members having threaded portions coupled to one another and a quantity of a sealant within the threaded portions of the tubular members.

According to another aspect of the present invention, a method of coupling an expandable tubular assembly including a plurality of tubular members having threaded portions to a preexisting structure is provided that includes coating the threaded portions of the tubular members with a sealant, coupling the threaded portions of the tubular members, curing the sealant, positioning the tubular members within a preexisting structure and radially expanding the tubular members into contact with the preexisting structure.

According to another aspect of the present invention, an apparatus is provided that includes a preexisting structure and a plurality of tubular members having threaded portions coupled to the preexisting structure by the process of: coating the threaded portions of the tubular members with a sealant, coupling the threaded portions of the tubular members, curing the sealant, positioning the tubular members within a preexisting structure and radially expanding the tubular members into contact with the preexisting structure.

### BRIEF DESCRIPTION OF THE DRAWINGS

FIG. 1 is a flow chart illustrating a preferred embodiment of a method for coupling a plurality of tubular members to a preexisting structure.

FIG. 2 is a cross-sectional view of an embodiment of the threaded connection between a pair of expandable tubulars.

FIG. 3 is a fragmentary cross sectional view of the radial expansion of the tubular members of FIG. 2 into contact with a preexisting structure.

### DETAILED DESCRIPTION

A method and apparatus for coupling tubular members to a preexisting structure is provided. In a preferred embodiment, the tubular members are coupled using threaded connection. The threaded connection is coated with a sealant material that is then allowed to cure. The tubular members are then radially expanded into contact with the preexisting structure. In this manner, the radially expanded threaded connection between the tubular members optimally provides a fluidic seal.

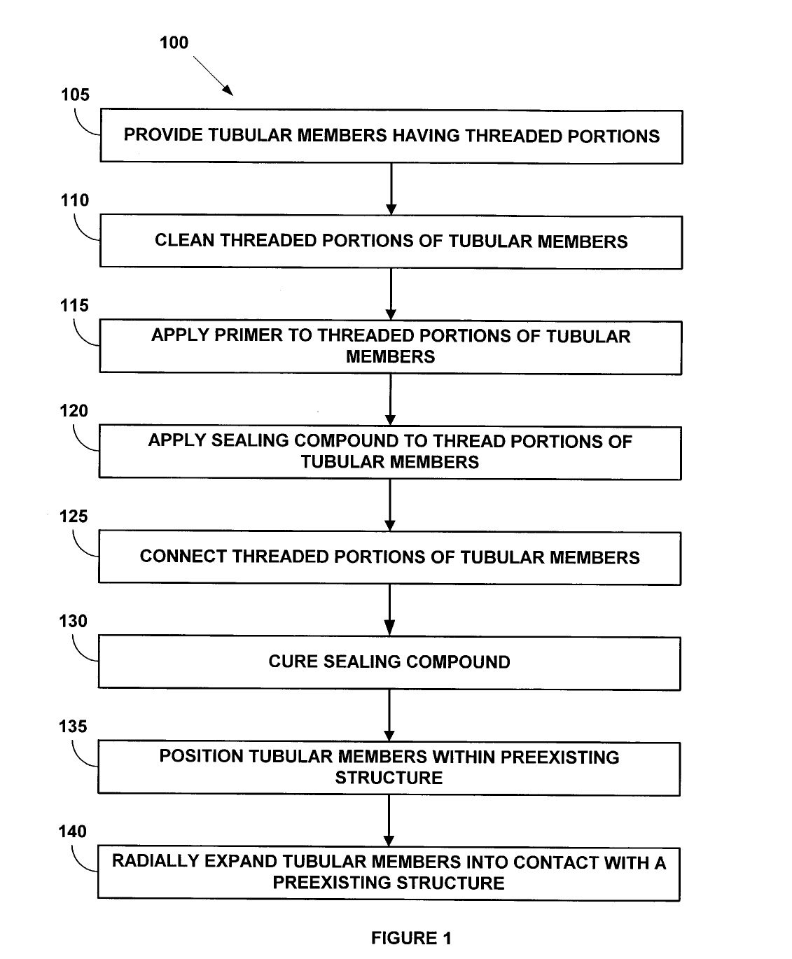

In FIG. 1, a preferred embodiment of a method 100 for forming and/or repairing a wellbore casing, pipeline, or structural support includes the steps of: (1) providing first and second tubular members having first and second threads in step 105; (2) cleaning the first and second threads in step 110; (3) applying a primer to the threaded portions of the tubular members in step 115; (4) applying a sealing compound to the first and second threads in step 120; (5) coupling the first and second threads of the first and second tubular members in step 125; (6) curing the sealing compound in step 130; (7) positioning the coupled first and second tubular members within a pre-existing structure in step 135; and (8) radially expanding the coupled first and second tubular members into contact with the preexisting structure in step 140.

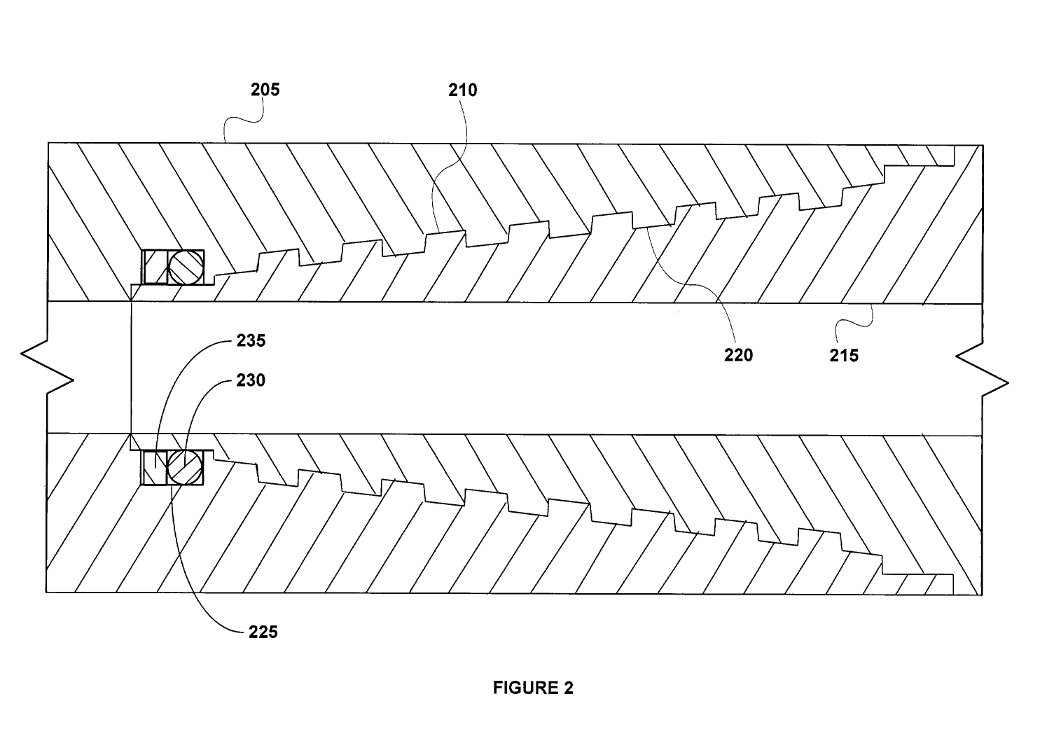

As illustrated in FIG. 2, in a preferred embodiment, in step 105, a first tubular member 205 including first threads 210 and a second tubular member 215 including second threads 220 are provided. The first and second tubular members, 205 and 215, may be any number of conventional commercially available tubular members. In a preferred embodiment, the first tubular member 205 further includes a recess 225 containing a sealing member 230 and a retaining ring 235. In a preferred embodiment, the first and second tubular members, 205 and 215, are further provided substantially as described in one or more of the following co-pending applications:

| U.S. Provisional | | |
|---|---|---|
| Patent Application | Attorney | |
| Number | Docket No. | Filing Date |
| 60/108,558 | 25791.9 | Nov. 16, 1998 |
| 60/111,293 | 25791.3 | Dec. 7, 1998 |
| 60/119,611 | 25791.8 | Feb. 11, 1999 |
| 60/121,702 | 25791.7 | Feb. 25, 1999 |
| 60/121,841 | 25791.12 | Feb. 26, 1999 |
| 60/121,907 | 25791.16 | Feb. 26, 1999 |
| 60/124,042 | 25791.11 | Mar. 11, 1999 |
| 60/131,106 | 25791.23 | Apr. 26, 1999 |
| 60/137,998 | 25791.17 | Jun. 7, 1999 |
| 60/143,039 | 25791.26 | Jul. 9, 1999 |
| 60/146,203 | 25791.25 | Jul. 29, 1999 |
| 60/154,047 | 25791.29 | Sep. 16, 1999 |
| 60/159,082 | 25791.34 | Oct. 11, 1999 |
| 60/159,039 | 25791.36 | Oct. 11, 1999 |

Applicants incorporate by reference the disclosures of these applications.

In a preferred embodiment, in step 110, the first and second threads, 210 and 220, are cleaned. The first and second threads, 210 and 220, may be cleaned using any number of conventional cleaning methods.

In a preferred embodiment, the first and second threads, 210 and 220, are cleaned to substantially remove all foreign material and surface corrosion.

In a preferred embodiment, in step 115, the first and/or second threads, 210 and 220, are coated with a primer material to improve the adhesion of the sealing compound to the first and second threads, 210 and 220. In a preferred embodiment, the coating of primer material includes transition metal such as, for example, zinc, manganese, copper, iron, and/or cobalt.

In a preferred embodiment, in step 120, the first and/or second threads, 210 and 220, are coated with a sealing compound. The sealing compound may be any number of conventional commercially available sealing compounds such as, for example, epoxies, thermosetting sealing compounds, curable sealing compounds, or sealing compounds having polymerizable materials. In a preferred embodiment, the sealing compound maintains its material properties for temperatures ranging from about 0 to 450° F., is resistant to common wellbore fluidic materials such as water, drilling mud, oil, natural gas, acids, CO₂, and H₂S, and can be stretched up to about 30-40% after curing. In a preferred embodiment, the sealing compound is Jet-Lock III High Friction Thread Compound available from Jet-Lube, Inc. in order to optimally provide a fluidic seal between the first and second threads, 210 and 220.

In an alternative preferred embodiment, in steps 115 and 120, the sealing compound is applied to one of the threads, 210 or 220, and a primer material with or without a curing catalyst is applied to the other one of the threads, 210 and 220. In this manner, the adhesion of the sealing compound to the threads, 210 and 220, is optimized.

In a preferred embodiment, in steps 125 and 130, the first and second threads, 210 and 220, of the first and second tubular members, 205 and 215, are then coupled, and the sealing compound is cured.

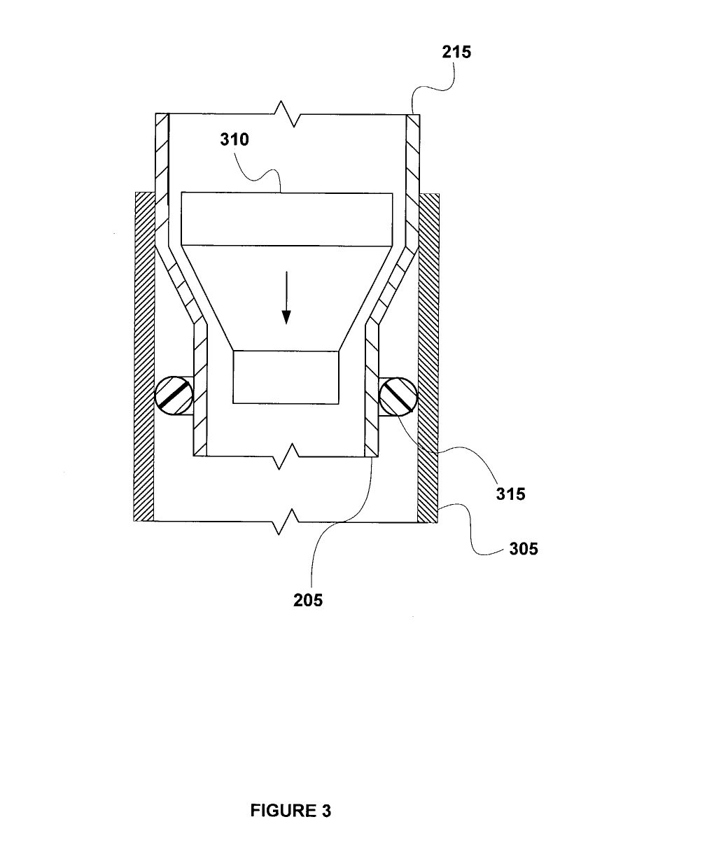

As illustrated in FIG. 3, in steps 135 and 140, the tubular members 205 and 215 are then positioned within a preexisting structure 305, and radially expanded into contact with the interior walls of the preexisting structure 305 using an expansion cone 310. The tubular members 205 and 215 may be radially expanded into intimate contact with the interior walls of the preexisting structure 305, for example, by: (1) pushing or pulling the expansion cone 310 through the interior of the tubular members 205 and 215; and/or (2) pressurizing the region within the tubular members 205 and 215 behind the expansion cone 310 with a fluid. In a preferred embodiment, one or more sealing members 315 are further provided on the outer surface of the tubular members 205 and 215, in order to optimally seal the interface between the radially expanded tubular members 205 and 215 and the interior walls of the preexisting structure 305.

In a preferred embodiment, the radial expansion of the tubular members 205 and 215 into contact with the interior walls of the preexisting structure 305 is performed substantially as disclosed in one or more of the following co-pending patent applications:

| U.S. Provisional | | |
|---|---|---|
| Patent Application | Attorney | |
| Number | Docket No. | Filing Date |
| 60/108,558 | 25791.9 | Nov. 16, 1998 |
| 60/111,293 | 25791.3 | Dec. 7, 1998 |
| 60/119,611 | 25791.8 | Feb. 11, 1999 |
| 60/121,702 | 25791.7 | Feb. 25, 1999 |
| 60/121,841 | 25791.12 | Feb. 26, 1999 |
| 60/121,907 | 25791.16 | Feb. 26, 1999 |
| 60/124,042 | 25791.11 | Mar. 11, 1999 |
| 60/131,106 | 25791.23 | Apr. 26, 1999 |
| 60/137,998 | 25791.17 | Jun. 7, 1999 |
| 60/143,039 | 25791.26 | Jul. 9, 1999 |
| 60/146,203 | 25791.25 | Jul. 29, 1999 |
| 60/154,047 | 25791.29 | Sep. 16, 1999 |
| 60/159,082 | 25791.34 | Oct. 11, 1999 |
| 60/159,039 | 25791.36 | Oct. 11, 1999 |

The disclosures of each of the above co-pending patent applications are incorporated by reference.

In an alternative preferred embodiment, the sealing compound is a 2-step sealing compound that includes an initial cure that is completed after the first and second threads, 210 and 220, of the first and second tubular members, 205 and 215, are coupled, and a final cure that is completed after the first and second tubular members, 205 and 215, are radially expanded. In this manner, an optimal fluidic seal is formed between the first and second threads, 210 and 220. In a preferred embodiment, the final cure of the sealing compound is delayed by applying an inhibitor to the sealing compound before or after its application to the first and second threads, 210 and 220.

An expandable tubular assembly has been described that includes a pair of tubular members having threaded portions coupled to one another and a quantity of a sealant within the threaded portions of the tubular members. In a preferred embodiment, the sealant is selected from the group consisting of epoxies, thermosetting sealing compounds, curable sealing compounds, and sealing compounds having polymerizable materials. In a preferred embodiment, the sealant includes an initial cure cycle and a final cure cycle. In a preferred embodiment, the sealant can be stretched up to about 30 to 40 percent without failure. In a preferred embodiment, the sealant is resistant to conventional wellbore fluidic materials. In a preferred embodiment, the material properties of the sealant are substantially stable for temperatures ranging from about 0 to 450° F. In a preferred embodiment, the threaded portions of the tubular members include a primer for improving the adhesion of the sealant to the threaded portions.

A method of coupling an expandable tubular assembly including a plurality of tubular members having threaded portions to a preexisting structure has also been described that includes coating the threaded portions of the tubular members with a sealant, coupling the threaded portions of the tubular members, curing the sealant, positioning the tubular members within a preexisting structure and radially expanding the tubular members into contact with the preexisting structure. In a preferred embodiment, the sealant is selected from the group consisting of epoxies, thermosetting sealing compounds, curable sealing compounds, and sealing compounds having polymerizable materials. In a preferred embodiment, the method further includes initially curing the sealant prior to radially expanding the tubular members and finally curing the sealant after radially expanding the tubular members. In a preferred embodiment, the sealant can be stretched up to about 30 to 40 percent after curing without failure. In a preferred embodiment, the sealant is resistant to conventional wellbore fluidic materials. In a preferred embodiment, the material properties of the sealant are substantially stable for temperatures ranging from about 0 to 450° F. In a preferred embodiment, the method further includes applying a primer to the threaded portions of the tubular members prior to coating the threaded portions of the tubular members with the sealant. In a preferred embodiment, the primer includes a curing catalyst. In a preferred embodiment, the primer is applied to the threaded portion of one of the tubular members and the sealant is applied to the threaded portion of the other one of the tubular members. In a preferred embodiment, the primer includes a curing catalyst.

An apparatus has been described that includes a preexisting structure and a plurality of tubular members having threaded portions coupled to the preexisting structure by the process of coating the threaded portions of the tubular members with a sealant, coupling the threaded portions of the tubular members, curing the sealant, positioning the tubular members within a preexisting structure, and radially expanding the tubular members into contact with the preexisting structure. In a preferred embodiment, the sealant is selected from the group consisting of epoxies, thermosetting sealing compounds, curable sealing compounds, and sealing compounds having polymerizable materials. In a preferred embodiment, the apparatus further includes initially curing the sealant prior to radially expanding the tubular members and finally curing the sealant after radially expanding the tubular members. In a preferred embodiment, the sealant can be stretched up to about 30 to 40 percent after curing without failure. In a preferred embodiment, the sealant is resistant to conventional wellbore fluidic materials. In a preferred embodiment, the material properties of the sealant are substantially stable for temperatures ranging from about 0 to 450° F. In a preferred embodiment, the apparatus further includes applying a primer to the threaded portions of the tubular members prior to coating the threaded portions of the tubular members with the sealant. In a preferred embodiment, the primer includes a curing catalyst. In a preferred embodiment, the primer is applied to the threaded portion of one of the tubular members and the sealant is applied to the threaded portion of the other one of the tubular members. In a preferred embodiment, the primer includes a curing catalyst.

Although this detailed description has shown and described illustrative embodiments of the invention, this description contemplates a wide range of modifications, changes, and substitutions. In some instances, one may employ some features of the present invention without a corresponding use of the other features. Accordingly, it is appropriate that readers should construe the appended claims broadly, and in a manner consistent with the scope of the invention.

What is claimed is:

1. An expandable tubular assembly, comprising:
a pair of tubular members having threaded portions coupled to one another; and
a quantity of a sealant within the threaded portions of the tubular members.

2. The assembly of claim 1, wherein the sealant is selected from the group consisting of epoxies, thermosetting sealing compounds, curable sealing compounds, and sealing compounds having polymerizable materials.

3. The assembly of claim 1, wherein the sealant includes an initial cure cycle and a final cure cycle.

4. The assembly of claim 1, wherein the sealant can be stretched up to about 30 to 40 percent without failure.

5. The assembly of claim 1, wherein the sealant is resistant to conventional wellbore fluidic materials.

6. The assembly of claim 1, wherein the material properties of the sealant are substantially stable for temperatures ranging from about 0 to 450° F.

7. The assembly of claim 1, wherein the threaded portions of the tubular members include a primer for improving the adhesion of the sealant to the threaded portions.

8. The assembly of claim 1, wherein the tubular members comprise wellbore casings.

9. The assembly of claim 1, wherein the tubular members comprise pipes.

10. The assembly of claim 1, wherein the tubular members comprise structural supports.

11. An apparatus, comprising:
a preexisting structure; and
a plurality of tubular members having threaded portions coupled to the preexisting structure by the process of:
coating the threaded portions of the tubular members with a sealant;
coupling the threaded portions of the tubular members;
curing the sealant;
positioning the tubular members within a preexisting structure; and
radially expanding the tubular members into contact with the preexisting structure.

12. The apparatus of claim 11, wherein the sealant is selected from the group consisting of epoxies, thermosetting sealing compounds, curable sealing compounds, and sealing compounds having polymerizable materials.

13. The apparatus of claim 11, further including:
initially curing the sealant prior to radially expanding the tubular members; and
finally curing the sealant after radially expanding the tubular members.

14. The apparatus of claim 11, wherein the sealant can be stretched up to about 30 to 40 percent after curing without failure.

15. The apparatus of claim 11, wherein the sealant is resistant to conventional wellbore fluidic materials.

16. The apparatus of claim 11, wherein the material properties of the sealant are substantially stable for temperatures ranging from about 0 to 450° F.

17. The apparatus of claim 11, further including:
applying a primer to the threaded portions of the tubular members prior to coating the threaded portions of the tubular members with the sealant.

18. The apparatus of claim 17, wherein the primer includes a curing catalyst.

19. The apparatus of claim 17, wherein the primer is applied to the threaded portion of one of the tubular members and the sealant is applied to the threaded portion of the other one of the tubular members.

20. The apparatus of claim 19, wherein the primer includes a curing catalyst.

21. The apparatus of claim 11, wherein the tubular members comprise wellbore casings.

22. The apparatus of claim 11, wherein the tubular members comprise pipes.

23. The apparatus of claim 11, wherein the tubular members comprise structural supports.

24. An expandable tubular assembly, comprising:
a pair of tubular members having threaded portions coupled to one another; and
a quantity of a sealant within the threaded portions of the tubular members;
wherein the sealant is selected from the group consisting of epoxies, thermosetting sealing compounds, curable sealing compounds, and sealing compounds having polymerizable materials;
wherein the sealant includes an initial cure cycle and a final cure cycle;
wherein the sealant can be stretched up to about 30 to 40 percent without failure;
wherein the sealant is resistant to conventional wellbore fluidic materials;
wherein the material properties of the sealant are substantially stable for temperatures ranging from about 0 to 450° F.; and
wherein the threaded portions of the tubular members include a primer for improving the adhesion of the sealant to the threaded portions.
